(19) United States
(12) Patent Application Publication
(10) Pub. No.: US 2022/0363955 A1
(43) Pub. Date: Nov. 17, 2022

(54) COMPRESSIBLE PRESSURE-SENSITIVE STRUCTURAL ADHESIVE FILM BASED ON A LATENT REACTIVE COMPOSITION

(71) Applicant: LOHMANN GMBH & CO. KG, Neuwied (DE)

(72) Inventor: Ruben FRIEDLAND, Andernach (DE)

(73) Assignee: LOHMANN GMBH & CO. KG, Neuwied (DE)

(21) Appl. No.: 17/618,294

(22) PCT Filed: Jun. 12, 2020
(86) PCT No.: PCT/EP2020/066318

§ 371 Date: Dec. 10, 2021

(30) Foreign Application Priority Data
Jun. 11, 2019 (DE) 10 2019 004 057.0

(51) Int. Cl. C09J 7/38; C09J 9/00; C09J 163/00; C09J 11/04; C08G 59/40; C08K 9/10

(52) U.S. Cl. CPC C09J 7/38; C09J 9/00; C09J 163/00; C09J 11/04; C08G 59/4021; C08K 9/10; C09J 2463/00; C09J 2301/412; C09J 2301/408; C09J 2301/302

(57) ABSTRACT

A pressure-sensitive structural adhesive film based on an epoxy resin composition, wherein the epoxy resin composition comprises a latent-reactive, thermally activatable curing agent for producing a structural bond after thermal curing and additionally a curing agent that cross-links at room temperature, wherein the not-cured adhesive film is compressible and therefore allows for tolerance compensation.

### CROSS REFERENCE TO RELATED APPLICATIONS

This application is a national stage U.S. patent application of International Application No. PCT/EP2020/066318, filed on Jun. 12, 2020, and claims foreign priority to German Patent Application No. DE 10 2019 004 057.0, filed on Jun. 11, 2019, the entirety of each of which is incorporated herein by reference.

### TECHNICAL FIELD

A compressible pressure-sensitive adhesive structural film based on a latent reactive composition, which is thermally activated and cross-linked and which is pressure-adhesive at room temperature in its not-cured state.

### DESCRIPTION OF THE RELATED ART

In the majority of cases, epoxy resin adhesives based on liquid adhesives are used for structural and semi-structural adhesive bonding of components (e.g. In automotive shell construction). They are applied using complex controlled dynamic or static dosage devices. The liquid adhesives are associated with the disadvantage that they provide no initial strength (also referred to as initial adhesive strength) so that the components to be joined have to be mechanically held in position during curing. This is for example achieved using welding spots or clamps.

According to the prior art, pressure-sensitive adhesive tapes keep the components in place immediately after joining, thus overcoming the aforementioned disadvantage of the liquid adhesives. They are reversible, i.e. repeated repositioning is still possible. Special types of these adhesive tapes may subsequently be subjected to a curing procedure during which they develop their final strength and durability performance. Curing is triggered using UV light, increased temperature or humidity. The curing is irreversible, so that subsequent repositioning is no longer possible.

WO 2015/011686 A1 describes an adhesive tape that can be used on oiled surfaces. However, this particular thermally cross-linking system does not have any pressure-sensitive adhesive properties at room temperature so that the components must be mechanically secured until final curing of the adhesive film.

Moreover, also pressure-sensitive adhesive films based on epoxy resin form part of the prior art, e.g. for adhesively joining mirror bases to windscreens, as disclosed in U.S. Pat. No. 5,587,236 A. This system is however not suitable for adhesion on oiled surfaces.

Systems using thermoplastic film formers for producing a pressure-sensitive adhesive film based on epoxy resin that is functional at room temperature are for example described in WO 2017/109011 A1. The limited layer thicknesses due to the production method constitutes a disadvantage of this type of adhesive films.

Moreover, a pressure-sensitive adhesive film based on epoxy resin is described in patent application PCT/EP2018/057550, which has not yet been published, that is suitable for bonding oiled surfaces that concurrently may be provided at thicknesses of 1 μm and 3000 μm.

None of the above adhesive films allow for tolerance compensation of the join partners to be joined to the same extent as it is possible with the liquid adhesives. However, given that real components will always come with tolerances caused by the manufacturing process, this constitutes an essential characteristic.

WO 2014/071334 A1 relates to an adhesive film based on epoxy resin, comprising core-shell rubber particles and thermally expansive microparticles that expand during curing subject to the influence of the curing temperature. This is associated with the disadvantage that the join partners are not optimally wetted prior to curing due to the join part tolerances and that this only occurs during the expansion stage during curing. Under these circumstances, however, adhesion to the join partner is no longer guaranteed as a consequence of the progressive cross-linking, so that often adhesion to the second join partner is compromised.

### DETAILED DESCRIPTION

The terminology used in the descriptions below is to be understood as follows:

Throughout the specification and claims, the following terms take the meanings explicitly associated herein, unless the context clearly dictates otherwise. The term “herein” refers to the specification, claims, and drawings associated with the current application. The phrase “in an embodiment” as used herein does not necessarily refer to the same embodiment, though it can. Furthermore, the phrase “in another embodiment” as used herein does not necessarily refer to a different embodiment, although it can. Thus, as described below, various embodiments can be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

“Latent reactive adhesive film” means an adhesive film, where the curing is effected by applying heat. The curing agent is provided in the adhesive film, but it only becomes active when the temperature rises or once a certain temperature has been reached.

“Adhesive film” hereinafter relates to any type of spatial adhesive system, i.e. not only adhesive films but also adhesive tapes, adhesive foils, adhesive strips, adhesive plates or adhesive stamped parts. Moreover, the term “adhesive tape” or “adhesive film” shall also comprise what is referred to as “transfer films”, i.e. adhesive tapes without backing.

The terms “pressure-sensitive adhesive”, “pressure-sensitively adhesive” or “pressure”-adhesive compounds are used for adhesive compounds or adhesive films that are capable of creating a bond between two join partners simply by applying pressure. In particular, also subject to relatively mild contact pressure, a durable bond with the join partner can be achieved. The bond is reversible, i.e. it can be reversed without destroying the join partners.

The term “compressible” hereinafter refers to a film adhesive or an adhesive film that can be subjected to pressure deformation prior to final thermal cross-linking and that returns to its original thickness after pressure relief.

“Structural” or “semi-structural” adhesive bonds refer to bonds having a bond strength of >2 MPa on all conventional substrates (e.g. aluminium, steel, GRP, CFK).

“Room temperature” shall mean a temperature of 23±2° C.

In an implementation described is a pressure-sensitive adhesive film having pressure-sensitive adhesive properties at room temperature and that can be employed on oiled surfaces, that is compressible in its not-cured state to compensate tolerances and that has high strength after curing (e.g. >10 MPa in the tensile shear test according to DIN EN 1465 using steel) as well as high resilience vs-A-vis environmental influences.

In an implementation, described is a pressure-sensitive adhesive film that can be produced without the use of film formers and solvents.

Accordingly, what is provided is a pressure-sensitive structural adhesive film based on an epoxy resin composition, wherein the epoxy resin composition comprises a latent reactive, thermally activatable curing agent for producing a structural bond after thermal curing. The epoxy resin composition additionally comprises a curing agent that cross-links at room temperature, wherein the not-cured adhesive film is compressible and therefore allows for tolerance compensation.

By using at least one curing agent that cross-links at room temperature, the production of a pre-polymer can be implemented or, in this case, of a pressure-sensitive spatial adhesive composite in the form of an adhesive tape, regardless of the layer thickness, without using a film former or anything similar. Moreover, acrylates and hotmelts can be dispensed with. Also, the present adhesive film has a thermal post-cross-linking potential.

Consequently, it is possible to generate an adhesive film through partial cross-linking of the epoxy groups using the curing agent that cross-links at room temperature. In particular, the manufacture of the adhesive film and the concurrent increase of viscosity and gelling of the polymer is not achieved by drying or UV polymerisation of acrylate groups but by pre-cross-linking of the epoxy resins and producing the pre-polymers from these epoxy resins. This partial reaction is analogous to the cross-linking reaction of a two-component liquid adhesive based on epoxy resin, however, unlike in that case, it is presently not completed thanks to the sub-stoichiometrical addition of the curing agent that cross-links at room temperature. Hence, there remains some reaction potential that can be harnessed in the final application for developing bond strength following thermal curing.

The additional use of corresponding expansive filler agents triggering an expansion during the production of the adhesive film due to the partial cross-linking of the epoxy groups creates an adhesive film that is compressible prior to the final thermal cross-linking.

Thus, the finished adhesive film can be applied on components with tolerances caused by the manufacturing process prior to curing and compensates for these tolerances by its compressing ability in analogy to a foam. Therefore, wetting of real components prior to curing across the entire surface can be ensured.

In an embodiment, the epoxy resin compound comprises 30 to 95% by weight of at least one epoxy component, 0.1 to 80% by weight of at least one thermally activatable curing agent, 0.1 to 90% by weight of at least one curing agent that cross-links at room temperature, 0 to 70% by weight of at least one accelerant, and 0 to 70% by weight of at least one expansive filler agent for expanding the pre-polymer, 0 to 70% by weight of at least one additive, whereas the % by weight of the components add up to 100%.

In another embodiment, the curing agent that cross-links at room temperature comprises at least one amine, amide and/or thiol. In this context, for example, primary or secondary amines, aliphatic amines, aromatic amines, polyamides, amidoamines, jeffamines, poly-thiols or mixtures of the above can be used. Depending on the curing agent that cross-links at room temperature, also other properties of the adhesive film can be influenced, such as for example its tensile strength.

A curing agent based on amine, amide and/or thiol allows for providing a flexible adhesive composite that is spatial and pressure-sensitive when in a not-cured state and that is easy to handle and that prevents slipping of the components after bonding until final curing due to its pressure-sensitive adhesive property.

In yet another application, the additive responsible for expanding has an activation temperature between 30° C. and 150° C. and a maximum degree of expansion between 40° C. and 150° C., particularly between 60° C. and 130° C.

In yet another embodiment, the not-cured adhesive film has a compression between 5 and 80% depending on the filler concentration and expansion.

In yet another embodiment, the adhesive film has an additional expansion during curing.

In an embodiment, a pressure-sensitive adhesive film provides adhesive strength of at least 0.2 N/mm in its not-cured state. The adhesive strength is determined on steel in reference to DIN EN 1939:1996 at 23° C.±2° C. and 50%±5% relative humidity at a peel-off speed of 300 mm/min and a peel-off angle of 180°. For the test, an etched PET foil with a thickness of 50 μm is used as a backing film. The test strip with a width of 25 mm is applied to the steel substrate using an application roller at 5 kg and a temperature of 23° C.±2° C. The adhesive film is peeled off 10 minutes after application, at 300 mm/min. The measurement value (in N/mm) is a mean value of five individual measurements.

Pressure-sensitive adhesive compounds are permanently pressure-sensitively adhesive, i.e. they have a sufficiently low viscosity and high initial adhesion so that they will wet the surface of the respective adhesion substrate already when subjected only to little pressure. The adhesion capacity of the adhesive compounds is based on their adhesive properties and their releasability is based on their cohesive properties.

In another embodiment, the compressible pressure-sensitive structural adhesive film has at least one backing. If a backing material is provided, it may be equipped with a (pressure-sensitive) adhesive compound on one side or on both sides that contains the compressible composition free from solvent and film formers, or is made thereof. The backing material comprises all spatial composites such as for example films, foams, tissues, fabrics, non-woven fabrics and papers or also combinations thereof. In this context, different backings can be combined with the adhesive compounds for different applications.

In a further development, the compressible pressure-sensitive structural adhesive film has no backing and is thus suitable for forming a transfer film.

In a transfer film or a transfer adhesive tape, the adhesive compound that corresponds to the finished adhesive film in its final state is applied to a flexible liner or between two flexible liners prior to application. The liners are equipped with a separating layer and/or they have anti-adhesive properties.

When two liners are used, for application of the adhesive film, one liner is removed first, and then the adhesive film with the now exposed adhesive surface is applied on a first join partner. Subsequently, the second liner is removed and the adhesive surface now exposed is joined to the second join partner. The adhesive compound can thus be used directly for joining two surfaces.

Such a pressure-sensitive transfer adhesive tape without backing allows for very precise adhesive application in respect of positioning and dosage.

Also adhesive films or adhesive tapes are feasible where just a single liner that is repellent on both sides is used instead of two liners. In this context, a first side of the adhesive film is covered with one side of the liner equipped with a repellent agent on both sides and a second side of the adhesive film is covered with the backside of the liner equipped with a repellent agent on both sides when it is wound onto a roll or a coil.

In a further development, the thickness of the latent reactive pressure-sensitive adhesive compound, both in the form of a transfer adhesive film and coated on a spatial composite, amounts to between 1 μm and 3000 μm, more to between 10 μm and 2000 μm and preferred in particular to between 50 μm and 1000 μm.

Layer thicknesses between 300 μm and 1000 μm are particularly suited for covering tolerances in the join partners to be bonded and are therefore for example often used in automotive shell construction. In combination with the compressible properties of the adhesive film, tolerances caused by the manufacturing process can thus be bridged and compensated for even better.

Layer thicknesses between 1 μm and 50 μm result in reduced adhesion to the join partners but will at the same time reduce material consumption.

The Epoxy Component

The latent reactive composition includes at least one epoxy component A. Essentially any epoxy resin or any material including epoxy known to the skilled person as suitable for use in adhesives and adhesive tapes can be used as the epoxy component. These are random organic compounds including at least one oxirane ring that can be polymerised by way of a ring opening reaction. Such materials comprise both monomer and polymer epoxies and they can be aliphatic, cycloaliphatic and aromatic. The materials referred to as epoxies generally have, on average, at least two epoxy groups per molecule, more than two epoxy groups per molecule. What is crucial for the subsequent stoichiometric cross-linking of the epoxy groups with the respective cross-linking agent is the epoxy equivalent weight (EEW, Epoxy Equivalent Weight). The EEW provides the mass in [g] of epoxy resin that possesses an equivalent [Eq] of epoxy functions. It is calculated according to the following formula:

$$E E W [ \frac{g}{E q} ] = \frac{{M}_{E p o x y} [ \frac{g}{mol} ]}{{f}_{E p o x y} [ \frac{E q}{mol} ]}$$

M_{Epoxy} as the molecular mass of the epoxy resin

f_{Epoxy} as the functionality of the epoxy

The polymer epoxies comprise linear polymers with terminal epoxy groups, polymers with structural oxirane units and polymers with epoxy lateral groups. Useful epoxies of this type are described in detail in U.S. Pat. No. 3,117,099 A.

Further materials containing epoxy comprise glycidyl thermo-monomers. Those are described in detail in U.S. Pat. No. 3,018,262 A.

A large number of commercially available materials containing epoxy and epoxy resins can be used. The following readily available epoxies are considered as particularly suitable, such as octadecylenoxide, epichlorhydrine, styroloxide, vinyicyclohexenoxide, viycidol, glycidylmethacrylate, diglycidylether of bisphenol A (e.g. those offered under the trade names EPON 828, EPON 1004 and EPON 1001F by Shell Chemical Co. and DER-332 and DER-334 by Dow Chemical Co.), diglycidylether of bisphenol F (e.g. ARALDITE GY281 by Ciba-Geigy), vinylcyclohexendioxide (e.g. ERL 4206 by the Union Carbide Corp.), 3,4-epoxycyclohexylmethyl-3,4-epoxycyclohexencarboxylate (e.g. ERL-4221 by the Union Carbide Corp.), 2-(3,4-epoxycyclohexyl5,5-spiro-3,4-epoxy)cyclohexane-metadioxane (e.g. ERL-4234 by the Union Carbide Corp.), bis(3,4-epoxycyclohexyl)adipate (e.g. ERL-4299 by the Union Carbide Corp.), dipentendioxide (e.g. ERL-4269 by the Union Carbide Corp.), epoxydised polybutadiene (e.g. OXIRON 2001 by the FMC Corp.), silicone resin containing epoxy functionality, epoxy silane (e.g. beta-(3,4-epoxycyclohexyl)ethyltrimethoxysilane and gamma-glycidoxypropyltrimethoxysilane, commercially available by Union Carbide), fire-resistant epoxy resins (e.g. DER-542, a brominated bisphenol type epoxy resin, offered by Dow Chemical Co.), 1,4-butandioldiglycidylether (e.g. ARALDITE RD-2 by Ciba-Geigy), hydrated epoxy resins based on bisphenol A-epichlorhydrine (e.g. EPONEX 1510 by Shell Chemical Co.) and polyglycidylether of phenol formaldehyde novolac (such as DEN-431 and DEN-438 by Dow Chemical Co.).

In a further embodiment, the pressure-sensitive structural adhesive film comprises at least 10% by weight of epoxy resins liquid at 25° C. in respect of the epoxy component A. The share of liquid epoxy resins in the epoxy component A in particular amounts to between 10% by weight and 100% by weight, further between 20% by weight and 95% by weight. A liquid epoxy resin or a mixture of different resins can be used.

In yet another embodiment, the latent reactive composition comprises 1 to 50% of the curing agent that cross-links at room temperature in relation to the epoxy equivalent weight of all epoxy resins or materials including epoxy used.

The Thermally Activatable Curing Agents

All known curing agents for epoxy resin adhesives are suitable as thermally activatable curing agents B, e.g. dicyandiamide as well as anhydride and mixtures thereof.

The Curing Agents that Cross-Link at Room Temperature

All known curing agents for epoxy resin adhesives are suitable as curing agents that cross-link at room temperature C, for example primary or secondary amines, aliphatic amines, aromatic amines, polyamides, amidoamines, jeffamines, phenalkamines, phenalkamides, polythiols or mixtures thereof. A selection of cross-linking agents is for example listed in the textbook “Formulierung von Kleb-und Dichtstoffen” [formulation of adhesive and sealants] by Bodo Müller and Walter Rath (Müller & Rath, 2009). Room temperature shall mean a temperature of 23° C.±2° C.

The Accelerants

All known accelerants for epoxy resin adhesives and adhesive tapes based on epoxy resin are suitable as accelerants D, e.g. imidazoles, urea derivatives (e.g. monuron, diuron, fenuron), tertiary amines or mixtures thereof. A selection of accelerants is for example listed in the textbook “Formulierung von Kleb-und Dichtstoffen” [formulation of adhesive and sealants] by Bodo Müller and Walter Rath (Müller & Rath, 2009)

The Additives

All known additives for adhesive tapes and pressure-sensitive adhesive compounds are suitable as additives, such as e.g. tackiflers, polymers, rheology modifiers, foaming agents, expanding agents, fillers, adhesion promoters, polyols, anti-oxidants, UV-protectors, UV-stabilisers, dyes, impact modifiers, phenoxy resins or mixtures thereof. Moreover, all additives can be used that are already listed in WO2017/174303 A1.

Generally, the adhesive films based on epoxy resin described herein can be produced using the three methods listed below:

a) Dissolving the epoxy resins, cross-linking agents, suitable film formers and optional additives in water or a solvent. Subsequent coating of this mixture and production of a sheet-shaped adhesive film by drying the adhesive compound.

b) Melting the epoxy resins, cross-linking agents, suitable film formers and optional additives and mixing of the individual components. Subsequently, the heated mass is coated and the sheet-shaped adhesive film is created by cooling down to room-temperature.

c) Mixing of the epoxy resins, the cross-linking agents and optional additives in acrylate monomers including photo initiators. The adhesive film is created by coating and polymerisation of the acrylate.

### DETAILED DESCRIPTION OF PREFERRED EMBODIMENTS

Described hereinafter are preferred embodiments.

Raw Materials Used:

| Brand name: | Description: |
|---|---|
| D.E.R. 671 | Solid epoxy resin based on bisphenol-A-diglycidylether with an |
| | epoxy equivalent weight of 475-550 g/eq, a softening temperature |
| | of 75-85° C. and an epoxy group content of 1820-2110 mmol/kg |
| | by the company DOW Chemical Co. |
| D.E.R. 331 | Epoxy resin based on bisphenol-A-diglycidylether with an epoxy |
| | equivalent weight of 182-192 g/eq by the company DOW |
| | Chemical Co. |
| D.E.R. 736 | Epoxy resin based on propylene glycol diglycidylether with an |
| | epoxy equivalent weight of 175-205 g/eq by the company DOW |
| | Chemical Co. |
| Struktol Polydis 3695 | Nitrile caoutchouc modified epoxy resin based on bisphenol-A- |
| | diglycidylether with an epoxy equivalent weight of 195 g/eq by |
| | the company Schill + Seilacher “Struktol”. |
| Struktol Polydis 3614 | Nitrile caoutchouc modified epoxy resin based on bisphenol-A- |
| | diglycidylether with an elastomer content of 40% and an epoxy |
| | equivalent weight of 330 g/eq by the company Schill + Seilacher |
| | “Struktol”. |
| Flexibilizer DY 965 CH | Phenol terminated polyurethane adduct with viscosity of 440- |
| | 1280 Pa · s at 40° C. by the company Huntsman. |
| HyPox RA 1340 | Nitrile caoutchouc modified epoxy resin based on bisphenol-A- |
| | diglycidylether with an elastomer content of 40% and an epoxy |
| | equivalent weight of 350 g/eq by the company CVC Thermoset |
| | Specialties, Inc. |
| Dyhard 100 S | Latent curing agent for hot-curing epoxy resin formulations |
| | based on dicyandiamide with an amine equivalent weight of 12- |
| | 14 g/eq by the company AlzChem Group AG. |
| Ancamine 2719 | Aliphatic poly-amine for epoxy resin formulations curing at room |
| | temperature with an amine equivalent weight of 75 g/eq by the |
| | company EVONIK Industries. |
| Ancamine 2609 | Aliphatic poly-amine for epoxy resin formulations curing at room |
| | temperature with an amine equivalent weight of 75 g/eq by the |
| | company EVONIK Industries. |
| Dyhard UR 500 | Di-functional, latent, micronised uron accelerant based on |
| | substituted urea by the company AlzChem Group AG, used as a |
| | latent accelerant with latent curing agents for hot-curing epoxy |
| | resin formulations. |
| Aerosil R202 | Pyrogenic silica by the company EVONIK Industries. |
| Microsphere F-35D | Thermally expansive filler by the company MATSUMOTO |
| Microsphere F-36D | YU-SHI-SEIYAKU Co., Ltd. |
| Expancel 920 DU 40 | Thermally expansive filler by the company Nouryon Akzo Nobel |
| | Chemicals GmbH |

Production of the Pressure-Sensitive Adhesive Compounds

For producing the respective pressure-sensitive compounds, the relevant solid resins on epoxy resin basis are dissolved in the liquid resins on epoxy resin basis as provided by stirring at 23° C. The thermally expansive filler is introduced to the homogeneous mass. Then, optionally the modified epoxy resins and the filler are added. Subsequently, the thermally activatable curing agent and optionally the accelerant are stirred into the resin compound.

For producing the adhesive compound layers, i.e. the (pressure-sensitive) adhesive tapes without backing, the different adhesive compounds are mixed with different concentrations of the curing agent that cross-links at room temperature and applied to a conventional liner (siliconized polyester film) using a laboratory coating device and pre-cross-linked. After pre-cross-linking, the thickness of the transfer film amounts to 200 t 15 μm. In analogy to drying a solvent-based adhesive film, precross-linking is first effected for ten minutes at room temperature and subsequently for 10 minutes at 90° C. Immediately after pre-cross-linking, the pre-cross-linked adhesive films are each laminated to a second liner (siliconized paper with less separating force than the first liner) on the exposed side.

The special aspect of the production of this transfer film is the generation of what is referred to as an expanded pre-polymer by cross-linking only part of the reactive groups of the epoxy resins used together with the curing agent that cross-links at room temperature. This means that the adhesive film is compressible prior to curing and that only at final adhesion of the substrates and downstream thermal curing the other reactive groups cross-link and generate a structural bond that can no longer be compressed at this stage.

The Composition of the Adhesive Compounds

In the following table, the compositions of the adhesive compounds are summarised in respect of the selection of the expanding filler additive, with the volume specifications indicating parts by weight:

| Example: | | K1 | K2 | K3 | K4 | R1 |
|---|---|---|---|---|---|---|
| Epoxy | D.E.R. 671 | 20 | 20 | 20 | 20 | 20 |
| components | D.E.R. 331 | 60 | 60 | 60 | 60 | 60 |
| | D.E.R. 736 | 55 | 55 | 55 | 55 | 55 |
| | Struktol Polydis | 27 | 27 | 27 | 27 | 27 |
| | 3695 | | | | | |
| | Struktol Polydis | 77 | 15 | 77 | 77 | 77 |
| | 3614 | | | | | |
| | Flexibilizer DY 965 | 15 | 15 | 15 | 15 | 15 |
| | HyPox RA 1340 | 0 | 62 | 0 | 0 | 0 |
| Thermally | Dyhard 100S | 8.1 | 8.1 | 8.1 | 8.1 | 8.1 |
| activatable | | | | | | |
| curing agent | | | | | | |
| Curing agents | Ancamine 2719 | 32.5 | 0 | 32.5 | 32.5 | 32.5 |
| that cross- | Ancamine 2609 | 0 | 32.5 | 0 | 0 | 0 |
| links at room | | | | | | |
| temperature | | | | | | |
| Accelerants | Dyhard UR 500 | 4.0 | 4.0 | 4.0 | 4.0 | 4.0 |
| Additive | Aerosil R202 | 2.0 | 2.0 | 2.0 | 2.0 | 2.0 |
| | Microsphere F-35D | 10 | 10 | 0 | 0 | 0 |
| | Microsphere F-36D | 0 | 0 | 10 | 0 | 0 |
| | Expancel 920 DU | 0 | 0 | 0 | 10 | 0 |
| | 40 | | | | | |

Results of the pressure-adhesive compounds regarding adhesive strength, tensile shear strength and tensile strength.

Adhesive Strength:

The adhesive strength is determined on steel in reference to DIN EN 1939:1996 at 23° C.±2° C. and 50%±5% relative humidity at a peel-off speed of 300 mm/min and a peel-off angle of 180°. An etched PET foil with a thickness of 50 μm is used as reinforcement foil. The test strip with a width of 25 mm is applied to the steel substrate using an application roller at 5 kg and at a temperature of 23° C.±2° C. The adhesive film is peeled off 10 minutes after application at 300 mm/min. The measurement value (in N/mm) Is a mean value of five individual measurements including standard deviation.

Tensile Shear Strength:

In order to determine parameters for adhesive strength on steel, tensile shear tests are carried out according to DIN EN 1465 at 23° C.±2° C. and 50%±5% relative humidity at a testing speed of 10 mm/min. 1,4301 alloy steels are used as test substrates; they are first cleaned with acetone and subjected to mechanical surface preparation using cross-grinding. The samples are each cured for 30 minutes at 130° C. The results are indicated in MPa (N/mm²). The figures stated are the mean value based on five measurements including standard deviation and failure pattern evaluation.

Tensile Strength:

In order to determine parameters for the strength of the adhesive film alone in its cured state, tensile tests are carried out according to DIN EN 527 at 23° C.±2° C. and 50%±5% relative humidity at a testing speed of 10 mm/min. To this end, strips of a width of 15 mm and of a length of 100 mm are cut out of cured adhesive films. In the results illustrated, the layer thickness amounts to 02 mm. The samples are cured for 30 minutes at 130° C. The results are indicated in MPa (N/mm²). The figures stated are the mean value based on five measurements including standard deviation.

Expansion:

Expansion after pre-cross-linking is carried out by measuring the layer thickness using a thickness gauge. A sample without fillers is used as reference that was produced with the same coating parameters. Measurements were taken once immediately after coating and thus the associated precross-linking as described above in the section Production of the pressure-sensitive adhesive compounds. Then, expansion was measured once more after curing for 30 minutes at 140° C. and subsequent cooling down to 23° C. Expansion derives from the following formula:

$$Expansion [ \% ] = \frac{\begin{matrix}100 \% Thickness of the adhesive \\ film modified with fillers\end{matrix}}{Thickness of the reference without fillers}$$

Compression

Compression is measured using a microscope of the type Keyence VHX-5000 with a magnification of 20×100. To this end, an adhesive film is clamped between two metal substrates, and film thickness is measured in the unloaded state. Subsequently, the clamped in adhesive film is exposed to a load of 100 N and film thickness is measured once more. Compression derives from the following formula:

$$Compression [ \% ] = \frac{100 \% \cdot Thickness of the loaded adhesive film [ mm ]}{Thickness of the unloaded adhesive film [ mm ]}$$

The following table indicates the results of the adhesive strength measurements, the tensile shear and tensile strength tests of the adhesive films as well as the associated expansion and compression measurements.

| Sample: | K1 | K2 | K3 | K4 | R1 |
|---|---|---|---|---|---|
| Adhesive strength | 0.66 ± 0.02 | 0.67 ± 0.02 | 0.69 ± 0.02 | 0.72 ± 0.06 | 1.15 ± 0.01 |
| [N/mm] | (AF/CF) | (AF/CF) | (AF/CF) | (AF/CF) | (AF/CF) |
| Tensile shear | 8 ± 1 (CF) | 8 ± 1 (CF) | 10 ± 1 (CF) | 11 ± 2 (AF) | 30 ± 0 (noF) |
| strength [MPa] | | | | | |
| Tensile strength | 7.8 ± 0.1 | 7.9 ± 0.1 | 8.4 ± 0.1 | 8.3 ± 0.3 | 46 ± 1 |
| [MPa] | | | | | |
| Expansion after | 220 ± 10 | 220 ± 10 | 190 ± 10 | 0 | 0 |
| 90° C. [%] | | | | | |
| Expansion after | 220 ± 10 | 220 ± 10 | 190 ± 10 | 160 ± 10 | 0 |
| 140° C. [%] | | | | | |
| Compression not- | ca. 30% | ca. 30% | ca. 30% | 0 | 0 |
| cross-linked @ 23° | | | | | |
| C. [%] | | | | | |

Key: AF: Adhesion Failure; CF: Cohesion Failure; SCF: Substrate-related special Cohesion Failure; noF: No Failure as the strength limit of the test device was reached.

Adhesive films K1, K3, K4 and R1 are of similar composition. Only the expansive filler is varied to illustrate differences in the selection of the carrier. Adhesive film K2 essentially corresponds to the adhesive compound of K1, only one epoxy resin component was substituted and the curing agent that cross-links at room temperature was exchanged.

Within the scope of the standard deviation, the adhesive compounds K1 and K2 exhibit the same mechanical behaviour and identical expansion and compression.

The adhesive films with the adhesive compounds K1, K3 and K4, within the scope of the standard deviation, exhibit no significant differences in terms of adhesive strength in their not-cured state. The reference adhesive compound R1 without filler agent exhibits higher adhesive strength in its not-cured state.

Tensile strength measurements do not show significant strength differences for the adhesive compounds K1 through K2 within the scope of the standard deviation. Only reference R1 without filler agents exhibits substantially higher tensile tear strength, due to the absence of expansive filler agents.

The tensile shear strength measurements of the adhesive films do not differ significantly in respect of the expansive filer agent used. Only reference R1 without filler agents once again exhibits higher strength by a factor of 5.

Expansion following complete pre-cross-linking at 90° C. for 10 minutes differs significantly for each different filler agent. Adhesive compounds K1 and K2 with identical expansive filler agents exhibit expansion of ca. 220%, whereas adhesive film K3 only exhibits expansion of about 190%. The reference without filler agents, like adhesive compound K4, exhibits no expansion, whereas in K4 this is due to the type of expansive filler agent used.

Expansion measurements after curing at 140° C. for 30 minutes show analogous results for adhesive compounds K1 through K3 in comparison to expansion measurements following pre-cross-linking at 90° C. Only adhesive film K4 exhibits expansion of about 160% after that curing. Adhesive film K4 is thus not compressible prior to curing, however, it expands during curing.

Due to the testing method used, compression could not be measured exactly. It very much depends on the filler agent concentration, the adhesive film thickness and previous expansion.

For adhesive films K1 through K3 compression after pre-cross-linking at 90° C. for 10 minutes amounts to ca. 30%. Due to the different type of expansive filer agent or the absence of such filler agent, adhesive compounds K4 and R1 are not compressible.

As far as applicable, all individual features shown in the sample embodiments can be combined and/or exchanged without leaving the scope of the invention.

1. A pressure-sensitive structural adhesive film based on an epoxy resin composition, the epoxy resin composition comprising: a latent-reactive thermally activatable curing agent for producing a structural bond after thermal curing, the epoxy resin composition further comprising a curing agent that cross-links at room temperature, wherein the not-cured adhesive film is compressible and therefore allows for tolerance compensation.

2. The pressure-sensitive structural adhesive film of claim 1, wherein the epoxy resin composition comprises:
a) 30 to 95% by weight of at least one epoxy component,
b) 0.1 to 80% by weight of at least one thermally activatable curing agent,
c) 0.1 to 90% by weight of at least one curing agent that cross-links at room temperature,
d) 0 to 70% by weight of at least one accelerant,
e) 0.1 to 70% by weight of at least one expansive filler agent for expanding the pre-polymer, and
f) 0 to 70% by weight of at least one additive,
wherein the % by weight of the components add up to 100%.

3. The pressure-sensitive structural adhesive film of claim 1, wherein the expansive filler agent has an activation temperature between 30° C. and 150° C. and a maximum degree of expansion between 40° C. and 150° C.

4. The pressure-sensitive structural adhesive film of claim 1, wherein the not-cured adhesive film has a compression between 5 and 80%.

5. The pressure sensitive structural adhesive film of claim 1, wherein the adhesive film has an additional expansion during curing.

6. The pressure-sensitive structural adhesive film of claim 1, wherein the adhesive strength according to DIN EN 1939 in the not-cured state amounts to at least 0.2 N/mm.

7. The pressure-sensitive structural adhesive film of claim 1 wherein the adhesive film for forming a transfer film has no backing.

8. The pressure-sensitive structural adhesive film of claim 1 wherein the adhesive film comprises a backing.

9. The pressure-sensitive structural adhesive film of claim 1 wherein the adhesive film has a thickness of between 1 μm and 3000 μm.

10. The pressure-sensitive structural adhesive film of claim 1 wherein the at least one epoxy component comprises at least 10% by weight.

11. The pressure-sensitive structural adhesive film of claim 1 wherein the latent reactive composition comprises 1 to 50% of the curing agent that cross-links at room temperature in relation to the epoxy equivalent weight of all of the epoxy resin, material including epoxy, or both, of the epoxy composition.

12. The pressure-sensitive structural adhesive film of claim 3 wherein the expansive filler agent has a maximum degree of expansion between 60° C. and 130° C.

13. The pressure-sensitive structural adhesive film of claim 9 wherein the adhesive film has a thickness of between 10 μm and 2000 μm.

14. The pressure-sensitive structural adhesive film of claim 13 wherein the adhesive film has a thickness of between particularly preferably between 50 μm and 1000 μm.

15. The pressure-sensitive structural adhesive film of claim 10 wherein the at least one epoxy component comprises between 20% by weight to 95% by weight, of an epoxy resin being liquid at 25° C.
